(19) United States
(12) Patent Application Publication
(10) Pub. No.: US 2023/0385348 A1
(43) Pub. Date: Nov. 30, 2023

(54) CONTENT MODERATION SERVICE FOR SYSTEM GENERATED CONTENT

(71) Applicant: Microsoft Technology Licensing, LLC, Redmond, WA (US)

(72) Inventors: Bernhard Kohlmeier, Seattle, WA (US); Natalie Ann Ramirez, Seattle, WA (US)

(21) Appl. No.: 17/825,734

(22) Filed: May 26, 2022

(51) Int. Cl. G06F 16/9536; G06F 40/205; G06F 40/279

(52) U.S. Cl. CPC G06F 16/9536; G06F 40/205; G06F 40/279

(57) ABSTRACT

A method carried out by a content moderation service can include receiving system generated content from an application identified as a result of detecting a trigger associated with a content moderation list in the system generated content, wherein the trigger associated with a content moderation list is a word, phrase, image, audio, or video indicated as requiring a moderation action; receiving context for the trigger, wherein the context for the trigger comprises other words or phrases or images or other media in proximity to the trigger; evaluating the trigger in combination with the context for the trigger according to a content moderation process to obtain a determination of a risk assessment; and providing the risk assessment to the application for determining the moderation action to the application.

### BACKGROUND

User-generated content (UGC) is any form of content, such as images, videos, text, and audio, that can be created, shared, or posted by users on online platforms such as social media, wikis, streaming channels, and online multi-player games. Content moderation tools are provided by the online platform or a third party to assist with content moderation of UGC. Content moderation tools enable the monitoring of content submitted/generated by users, the applying of rules that define acceptable content, and the removal or replacement of problematic content. Indeed, content moderation tools for UGC allow for the UGC to be reviewed for text, images, and video that could be problematic or provide a reporting function where other users may flag content for review. Content moderation can be manual or automated. Example automated content moderation includes blocking specific users, allow-listing certain users, keyword blocking or filters, and image filters. Accordingly, there are a number of tools available for UGC moderation that can include certain automated processes as well as support human review and intervention.

In contrast to the systems in place for UGC content moderation, when it comes to system generated content (SGC), most methods of managing such content rely on the developers to use appropriate terminology and/or program auto-generated content in a manner that avoids certain words or phrases. Certain systems use block lists or filters to prevent a user from being exposed to unwanted content, for example, to keep profanity or nudity from being available. The use of individual blocklists can create inconsistencies across features and applications without any explanation as to why certain content is blocked in one versus the other.

SGC can be any content that a system creates and presents to a user and may include output of recommender systems. One challenge for moderating SGC is that automated tools can be blunt instruments where designs either over block for terms that are only sensitive in context or inadvertently allow content that can be harmful to users through.

### BRIEF SUMMARY

A content moderation service for system generated content is provided. Through the described service, user generated content moderation systems can be leveraged for moderation of system generated content. Further, the interplay between system generated content and user generated content can be captured so that context for the system generated content, including any user generated content surrounding the system generated content or influencing the system generated content, can be considered when determining whether the particular system generated content contains something that may be an issue. Through the described system and techniques, information about risk can be provided to an application or feature so that the application or feature can use that information to determine what to suggest, recommend, offer, or otherwise act.

A method carried out by a content moderation service can include receiving a system generated content from an application identified as a result of detecting a trigger associated with a content moderation list in the system generated content, wherein the trigger associated with a content moderation list is a word, phrase, image, audio, or video indicated as requiring a moderation action; receiving context for the trigger, wherein the context for the trigger comprises other words or phrases or images in proximity to the trigger; evaluating the trigger in combination with the context for the trigger according to a content moderation process to obtain a determination of a risk assessment; and providing the risk assessment to the application for determining the moderation action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example scenario incorporating system generated content.

FIG. 2 illustrates a process by which trigger words in system generated content can be updated.

FIGS. 3A-3D illustrate an example operation of content moderation for system generated content.

FIG. 4 illustrates an operating environment of a content moderation service for system generated content.

FIG. 5 illustrates a method carried out by a content moderation service.

FIGS. 6A and 6B illustrate example scenarios of system generated content being evaluated using a content moderation service.

FIG. 7 illustrates components of a computing device on which a user may create user generated content.

FIG. 8 illustrates components of a computing system that may be used to carry out processes described herein.

### DETAILED DESCRIPTION

A content moderation service for system generated content is provided. Through the described service, user generated content moderation systems can be leveraged for moderation of system generated content. Further, the interplay between system generated content and user generated content can be captured so that context for the system generated content, including any user generated content surrounding the system generated content or influencing the system generated content, can be considered when determining whether the particular system generated content contains something that may be an issue. Through the described system and techniques, information about risk can be provided to an application or feature so that the application or feature can use that information to determine what to suggest, recommend, offer, or otherwise act.

Advantageously, by capturing results of system generated content (SGC) and running the SGC through systems the same as or similar to those treating UGC (e.g., evaluating content based on certain rules such as for keywords being present in the content), it is possible to provide additional protection against problematic content and the flags produced by evaluating the system generated content can be used to retrain models of the systems generating the SGC. That is, the systems generating the SGC through, for example, various artificial intelligence features, can determine whether the output of the system (i.e., the SGC) contains content that can be harmful/risky to users. The content moderation service directly and through feedback mechanisms (e.g., for use in retraining models at the system generating the SGC) allows for reducing over-blocking for terms that are only sensitive in context.

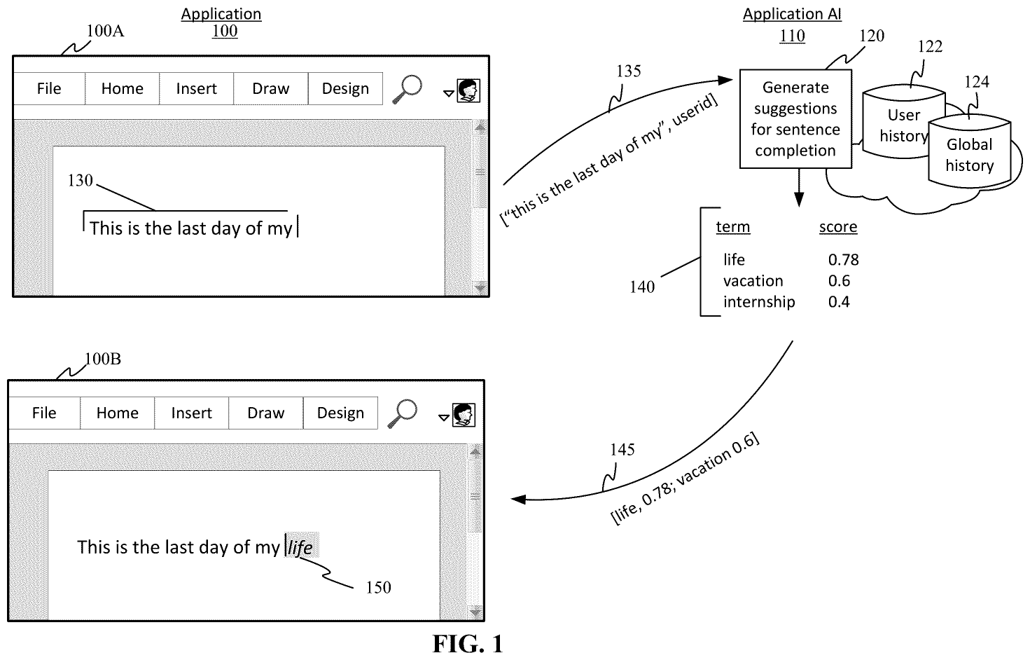

As an illustrative scenario, assume that a young intern is reflecting upon their time with their company and sets out to write “This is the last day of my . . . ” and the auto-complete suggestion function in their word processing application suggests the word “life” to complete the sentence by a single input (e.g., swipe, tab, enter) instead of the user needing to type the next word (or words) (see e.g., scenario shown in FIG. 1, described below). However, a suggestion of “life” in the context of the intern's user-generated content invokes a potentially risky sentence reflecting suicidal ideation. If the word processing application's artificial intelligence system was using a keyword block list or other typical developer-controlled content moderation approach, the choice would generally be to over-block the term “life” from being suggested or always allow this potentially problematic scenario to occur. The term “life”, as many would agree, is a very common word, with an abundance of uses that do not invoke suicidal ideation. Consider phrases like “what a great . . . ” or “I love my . . . ”. These phrases are perfectly acceptable situations for a system to generate the suggestion of “life”. However, currently, the system is unable to differentiate between adding the word “life” to “What a great” and “This is the last day of my”. Indeed, there is no “logical” or “practical” reason to not suggest the word “life” to complete this phrase. By all accounts, it is grammatically and situationally the correct way to use the word. However, colloquially, it is not the most appropriate suggestion for the system to make. Therefore, if the system treats the word “life” similar to certain hate speech or curse words, unnecessary over-blocking would occur. Indeed, not including the word “life”, just because there are rare situations it may be inappropriate would result in situations where “life” would be the most likely (and benign) next word of a sentence, but would not be presented for use

FIG. 1 illustrates an example scenario incorporating system generated content. A variety of applications include artificial intelligence (AI) features (such as machine learning features) that assist with user experience. For example, content creation applications use AI features to predict tools that a user may want to use next, to incorporate additional content, to suggest designs/layout, to generate new content, to assist with transcription or voice-to-text, and even to assist with completion of a sentence. As another example, search engines may use AI features to assist with autocomplete of search queries. As yet another example, productivity applications (some of which may also be considered content creation applications) may use AI to predict tools, content (including sentence or input field completion), and other aspects. As yet another example, voice assistants may present curated content in response to user queries and other interactions. Examples of content creation applications include, but are not limited to, note-taking applications such as MICROSOFT ONENOTE and EVERNOTE, freeform digital canvases such as GOOGLE JAMBOARD and MICROSOFT Whiteboard, word processing applications such as MICROSOFT WORD, GOOGLE DOCS, and COREL WORDPERFECT, spreadsheet applications such as available in GOOGLE DOCS and MICROSOFT EXCEL, presentation applications such as MICROSOFT POWERPOINT and PREZI, as well as various productivity, computer-aided design, blogging, and photo and design software. Example of productivity applications include, but are not limited to, any of the above-mentioned content creation applications, messaging applications such as for email, text, and chat, and collaborative channel applications such as MICROSOFT TEAMS and SLACK. Example search engines include, but are not limited to, MICROSOFT BING and GOOGLE SEARCH. Example voice assistants include, but are not limited to MICROSOFT CORTANA, APPLE SIRI, GOOGLE ASSISTANT, and AMAZON ALEXA.

Referring to FIG. 1, in an application with an artificial intelligence feature (Application 100), a user is creating content. The artificial intelligence feature can be supported by an Application AI 110, which in the illustrated scenario generates (120) suggestions for sentence completion. The Application AI 110 may be running locally at the client device on which Application 100 is running or may be provided as a service for Application 100 that is accessible over a network (e.g., at an enterprise server or as a cloud service). In the illustrated example, Application AI 110 is operating as part of user services in a multi-user system. Application 100 communicates information such as content created by the user (and optionally context) and a user identifier (“userid”) to the Application AI 100, which uses the received information to generate (120) the suggestion for sentence completion using models that may be based on the user's own history 122 and/or global history 124 of all the users (and possibly other sources).

Following the example of the intern described above, in state 100A of the graphical user interface (GUI) of Application 100, a user creates UGC 130, stating “This is the last day of my”. The UGC 130 (and optional context) is communicated (135) to Application AI 110, for example using any suitable data exchange protocol such as hypertext transfer protocol (HTTP). In response, Application AI 110 generates (120) a list of word suggestions 140 to serve as auto-complete suggestions to logically follow the UGC 130.

In the example illustrated by FIG. 1, the Application AI 110 produces system generated content including three results: “life”, “vacation”, and “internship.” Each of the generated word suggestions is given a score indicating how confident Application AI 110 is that a given suggestion is the “best” logical completion to the UGC 130. The term “life” is given a score of 0.78, “vacation” is given a score of 0.6, and “internship” is given a score of 0.4. In this example, an arbitrary threshold score is set at 0.50; suggestions with scores over the threshold score are returned (145) to the Application 100 as suggestions for completing the sentence for the UGC 130. Since both “life” and “vacation” meet the threshold score, both of these suggestions are sent to the Application 100. The Application 100 may determine what to present to the user. For example, the Application 100 may have its own threshold, weighting, or ranking to apply and may present none, one, some, or all of the results received from the Application AI 110. As can be seen in FIG. 1, the Application 100 surfaces the highest scoring suggestion “life” in state 100B of the GUI as a suggestion 150 for completing the UGC 130 sentence.

While the Application AI 110 has determined that the system generated content “life” may be a relevant word to complete UGC 130 “This is the last day of my”, it is not necessarily an appropriate word, particularly given the context provided by the UGC 130. Suggesting “life” as an autocomplete suggestion in many contexts is both suitable and appropriate. However, the combination of the UGC 130 “This is the last day of my” and the suggestion “life” creates a sentence rife with suicidal ideation. There is a clear distinction between system generated content that is suitable or relevant to suggest, and system generated content that is appropriate to suggest in context of the current content (whether user generated or system generated).

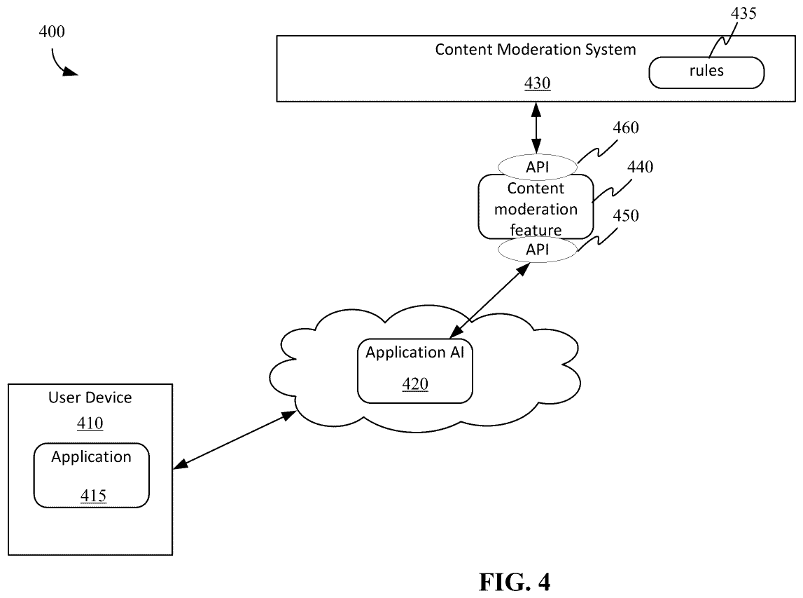

To address the potential of the system-generated term “life” as having problematic contexts, the system generated content can be evaluated by content moderation systems through the described content moderation service. The content moderation service can be considered a system generated content moderation feature that may be a standalone service or integrated with a content moderation system or application server, described in more detail with respect to FIG. 4.

Initially, for the Application AI 110 to recognize that the term “life” could be a trigger that may require a content moderation action (e.g., provide a content warning, avoid use of the term, request moderation review, etc.), Application AI 110 either is informed that the word may be problematic (e.g., by adding the term to a list or by incorporating in some other form such as a model used in generating the content) or uses the content moderation feature to identify triggers. The described content moderation service/feature can provide a feedback mechanism to be used to update the models at the Application AI 110 and/or may evaluate the system generated content for triggers itself.

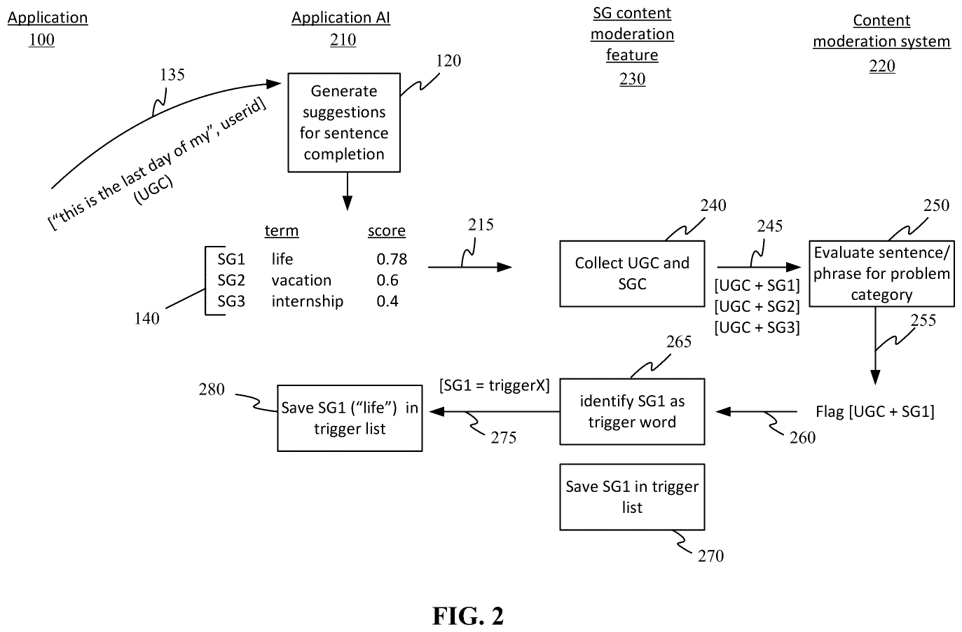

FIG. 2 illustrates a process by which trigger words in system generated content can be updated. The processes illustrated in FIG. 2 may be carried out in an operating environment 400 as described with respect to FIG. 4. A trigger is a word, phrase, image or other media (e.g., video, audio) associated with a content moderation list that may require a moderation action. System generated content may be recognized as a trigger when the system generated content is found on a content moderation list. A content moderation list involves a list of rules and principles (if/then) created to provide moderation to content. A content moderation list may be generated or produced by various methods. Content moderation lists often include and utilize a category system for sorting and classifying various types of content. For example, content may be separated based on severity. As an example, one severity level (which also may be considered a high severity level) may include terms that are highly offensive or problematic, regardless of their context. Content that may fall into such a severity level may include, but is not limited to, taboo words, profanity, extreme concepts and language, highly sexualized content, and others. By contrast, a lower severity level may include words or phrases that carry a low risk of harm in some contexts but can be problematic or offensive in others. Given this dependence on context, it may be difficult to consistently update and improve the content moderation list in a category found in a lower severity level, where context is extremely important. Because of this, in order to efficiently and effectively moderate system generated content based on context, the content moderation lists are continuously being updated with words, phrases, images, audio, or video that in some contexts (no matter how limited) could be inappropriate. In some cases, a lower severity level content category may also contain metadata on the area being covered (e.g., self-expression).

Referring to FIG. 2, an example process for updating content moderation lists with new context specific triggers can involve sending all the system generated content through a content moderation system for evaluation. For example, a content moderation feature 230 can request a tracking set of system generated content and associated content used by the application 100 to generate each system generated content of the tracking set of system generated content; and evaluate the tracking set of system generated content and associated content according to the content moderation process to identify any system generated content of the tracking set of system generated content that results in a particular moderation action or a particular risk assessment (e.g., information of severity level). The associated content used by the application to generate each system generated content of the tracking set of system generated content can include other system generated content, user generated content, or a combination thereof

Returning to the example scenario of FIG. 1, when Application 100 sends (135) the UGC to the corresponding Application AI to generate (120) suggestions for sentence completion, Application AI 210 can send (215) the generated content 140 to a content moderation system 220 via the system generated (SG) content moderation feature 230. Here, to complete the UGC “This is the last day of my,” the Application AI 210 generates the system generated content 140, including SG1 “life”, SG2 “vacation”, and SG3 “internship”. The SG content moderation feature 230 collects (240) the system generated content 140 and the context for the system generated content 140 (in this case is the UGC “This is the last day of my”). The Application AI 210 or the SG content moderation feature 230 labels the content to distinguish the system generated content from the UGC (which assists with later operations). The SG content moderation feature 230 can combine each of the system generated content 140 with the context to send (245) to the content moderation system 220 for evaluation. As shown, three independent results are created at the SG content moderation feature 230, UGC+SG1, UGC+SG2, and UGC+SG3.

The content moderation system 220 can evaluate (250) each resulting combination to determine if the combination falls within a content moderation category. Because the SG content moderation feature 230 creates the combined system generated content and context (e.g., UGC+SG1), the content moderation system 220 can treat the received independent results as user generated content and utilize existing rules for user generated content (which are updated in accordance with any suitable methodology). For example, as seen in FIG. 2, the combined phrase of UGC+SG1 is “This is the last day of my life”, and the combined phrase of UGC+SG2 is “This is the last day of my vacation.” These combinations are each evaluated (250) and are flagged when the result comprises content falling into a content moderation problem category recognized by the content moderation system 220.

In particular, the combinations produced by combining [UGC+SG2] and [UGC+SG3] are not flagged by the content moderation system 220 because neither combination produces content that falls into an established categorical content moderation problem. However, the content moderation system 220 will flag (255) the combination of [UGC+SG1]. This combination is flagged because the combined sentence “This is the last day of my life” is recognized by the content moderation system as suicidal ideation.

The content moderation system 220 sends (260) a flagged [UGC+SG1] back to the SG Content Moderation Feature 230. The SG Content Moderation Feature 265 identifies and classifies the system generated content SG1 “life” as a trigger word. This is because, as the content moderation system flag denotes, there exists a combination SG1 “life” and context (UGC) that may be flagged for falling into a content moderation problem category. As a result, the SG Content Moderation Feature 230 can save (270) SG1 “life” in a trigger list. In some embodiments, SG Content Moderation Feature 230 may also notify (275) Application AI 210 to save (280) SG1 “life” in a trigger list. Because at least the system generated content of the combined UGC and SG1 is labeled as system generated content, the SG content moderation feature 230 is able to extract the system generated term from the flagged sentence/phrase received from the content moderation system 220. Once the Application AI 210 and/or the SG content moderation feature 230 has a particular content on a trigger list, normal operation of the Application AI 210 will trigger content moderation when that particular content is generated by the Application AI 210.

In some cases, the content moderation feature 230 can label each identified system generated content of the tracking set (e.g., as described above) of system generated content that results in the particular moderation action or the particular risk assessment as a new trigger; and communicate with the application or the application AI 210 to update a model with the new triggers. In some cases, the content moderation feature 230 can perform statistical analysis with respect to each identified system generated content of the tracking set of system generated content that results in the particular moderation action or the particular risk assessment, which may be used to further assist either the content moderation system 220 or the application AI 210.

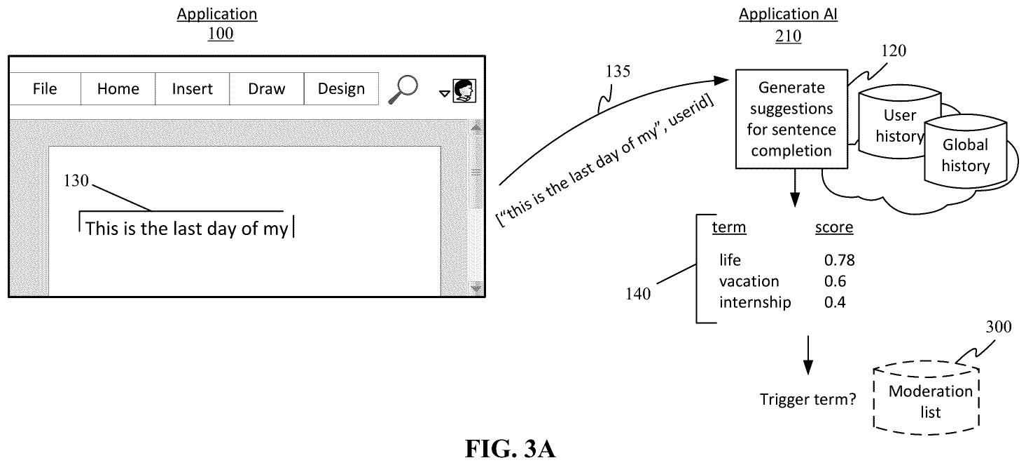

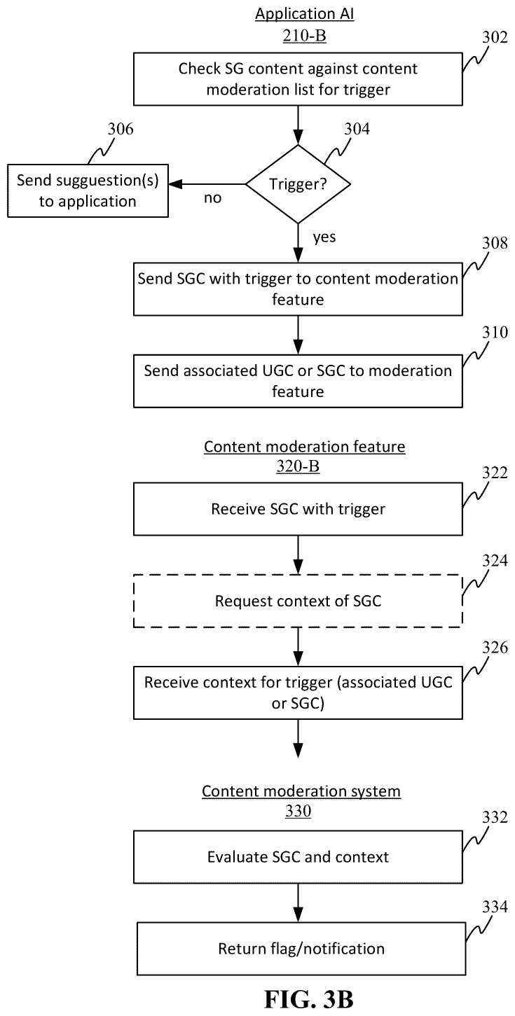

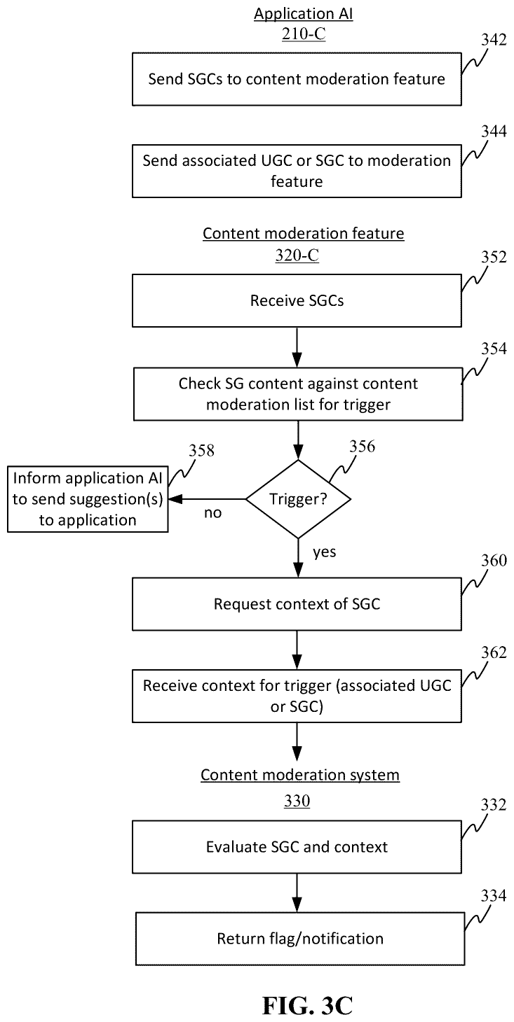

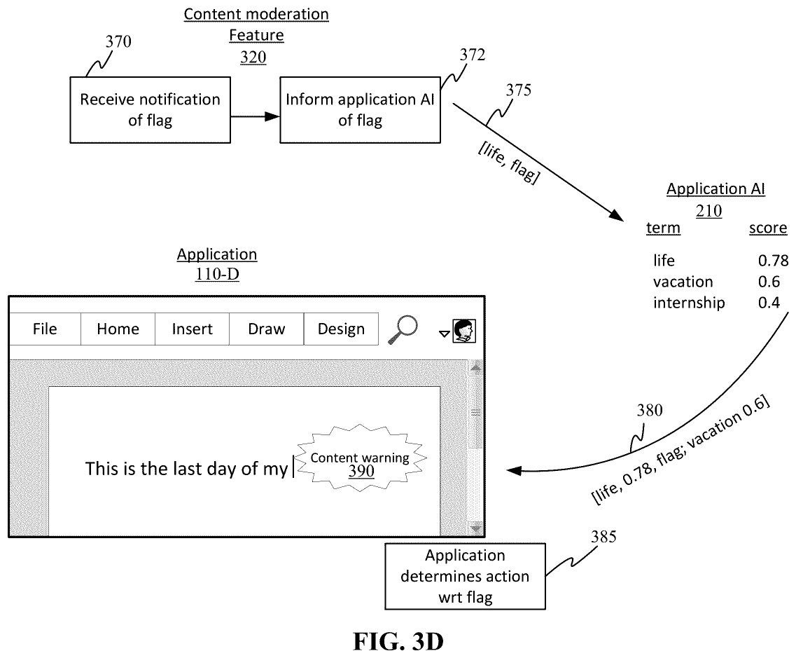

FIGS. 3A-3D illustrate an example operation of content moderation for system generated content The processes illustrated in FIGS. 3A-3D may be carried out in an operating environment 400 as described with respect to FIG. 4. Referring to FIG. 3A, as described with respect to the original scenario of the user entering the UGC 130 phrase “This is the last day of my” within a GUI of Application 100, the Application 100 sends (135) the UGC (and optional context) to an Application AI 210 for generating system generated content 140. In this illustrative scenario, the Application AI 210 directly (see e.g., FIG. 3B) or via a SG moderation feature (see e.g., FIG. 3C) includes the term “life” in the trigger/moderation list 300.

In the implementation reflected in FIG. 3B, Application AI 210-B checks (302) the system generated content 140 against the content moderation list 300 for a trigger to determine (304) whether a trigger is present. In some cases, the checking step can be carried out using a keyword block or filter or an image block or filter. If the Application AI 210-B determines in operation 304 that no triggers are present in the system generated content 140, the Application AI 210-B sends the system generated content 140 suggestions to the Application 100 based on established criteria (e.g., threshold confidence value). If the Application AI 210-B determines in operation 304 that there is a trigger present in the system generated content 140, the Application AI 210-B sends (308) the system generated content with trigger to the content moderation feature 320-B to obtain a risk assessment to enable determination of a moderation action (if any).

In the present example, the system generated content 140 suggestion “life” is flagged as a trigger word by the Application AI 210-B, as “life” is present on the trigger/moderation list 300 (e.g., resulting from the process described with respect to FIG. 2). As a result, Application AI 210-B sends (308) the system generated content 140 suggestion “life” to the SG Content Moderation Feature 320-B.

The Application AI 210-B can also send (310) associated user generated content and/or system generated content which may surround the suggestion to the SG Content Moderation Feature 320-B.

Content Moderation Feature 320-B receives (322) the system generated content with the trigger and, if not received with the system generated content, requests (324) the context of the system generated content from the Application AI 210-B. The Content Moderation Feature 320-B receives (326) the context for the trigger, which is the associated user generated content and/or system generated content which may surround the suggestion. The combination of the system generated content with the trigger and the context (of the associated UGC or surrounding system generated content) is provided to the content moderation system 330 by the content moderation feature 320-B.

The content moderation system 330 evaluates (332) the system generated content and context in accordance with the rules at the system and returns (334) a flag or notification regarding a risk assessment to the content moderation feature 320-B for informing the Application AI 210-B. In some cases, the flag or notification includes information of the severity level (e.g., high severity level, lower severity level, etc.).

In the implementation reflected in FIG. 3C, Application AI 210-C sends all of the system generated content 140 suggestions to the SG Content Moderation Feature 320-C. This may occur, for example, when the SG Content Moderation Feature 320-C manages the moderation list 300 for the Application AI 210-C.

The SG Content Moderation Feature 320-C receives (352) the system generated content 140 from the Application AI 210-C and checks (354) each of the system generated content 140 against the content moderation list 300 for a trigger to determine (356) whether a trigger is present If the SG Content Moderation Feature 320-C determines in operation 356 that no triggers are present, the SG Content Moderation Feature 320-C informs (358) the Application AI 210-C that the Application AI 210-C can send suggestion(s) to Application 100 (e.g., based on established criteria). The communication informing the Application AI 210-C may indicate no triggers were present. If the Content Moderation Feature 320-C determines in operation 356 that there is a trigger present in the system generated content 140, the Content Moderation Feature 320-C requests (360) the context of the system generated content with the trigger. The Content Moderation Feature 320-C can request the context from the Application AI 210-C; and the Application AI 210-C sends (344) the associated UGC or system generated content to the Content Moderation Feature 320-C.

The Content Moderation Feature 320-C receives (362) the context for the trigger, which is the associated user generated content and/or system generated content which may surround the suggestion. The combination of the system generated content with the trigger and the context (of the associated UGC or surrounding system generated content) is provided to the content moderation system 330 by the content moderation feature 320-C; and as described with respect to FIG. 3B, the content moderation system 330 evaluates (332) the system generated content and context in accordance with the rules at the system and returns (334) a flag or notification regarding a risk assessment to the content moderation feature 320-C for informing the Application AI 210-C. As mentioned above, in some cases, the flag or notification includes information of the severity level (e.g., high severity level, lower severity level, etc.).

As illustrated in FIG. 3D, when the system generated content (e.g., “life”) is determined by the content moderation system 330 be part of content requiring a flag, the Application AI 200 is notified of the flag (e.g., via content moderation feature 320). For example, the Content Moderation Feature 320 receives the notification of flag from the Content Moderation System 330. The content moderation feature 320 can identify the system generated content portion of the phrase/sentence to inform (372) the Application AI 210 of the flag; and communicates (375) the system generated content suggestion “life” with a flag to Application AI 210. Thus, when the Application AI 210 returns (380) the suggestions to the Application 100-D, the suggestion “life” includes a flag. The Application 110-D determines (385) action with respect to the flag. For example, the term “life” can still be presented to the user as a suggestion even though it may convey an undesirable topic. In some cases, the Application 110-D may have a setting that is adjustable by the user to allow for certain topics to still be shown. In some cases, flagged system generated content is presented with a warning 390. This warning may include, but is not limited to, an alert, a pop-up, a permissions request, a summary including the type of content moderated, etc.

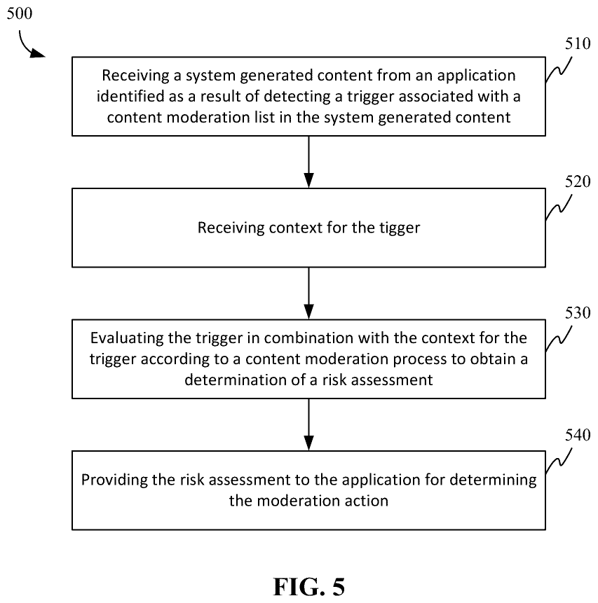

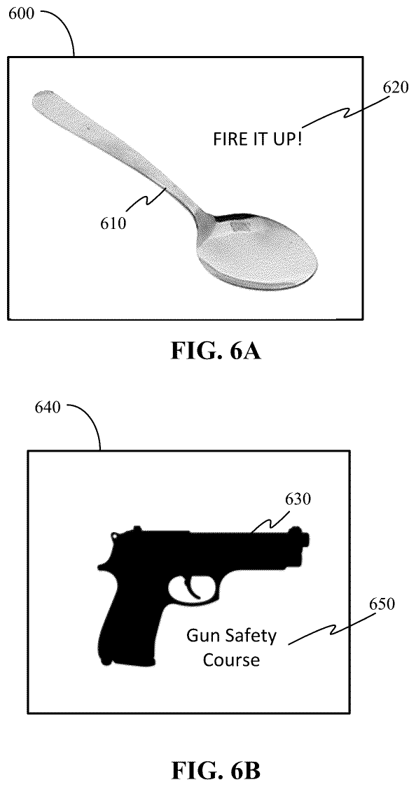

FIG. 4 illustrates an operating environment of a content moderation service for system generated content. Referring to FIG. 4, an operating environment 400 for content moderation services of system generated content includes a user device 410 with an application 415 having an associated application AI feature 420, a content moderation system 430 operating according to specified rules 435 and a content moderation feature 440 which can include APIs 450 for communications between the content moderation feature 440 and the application AI feature 420 and APIs for communications between the content moderation feature 440 and the content moderation system 430. Content moderation feature 440 performs the processes described herein for providing a content moderation service for system generated content, including method 500 described with respect to FIG. 5, which may be performed in the scenarios as described with respect to FIGS. 3A-3D (and FIGS. 6A and 6B).

Content moderation feature 440 may be implemented as part of the content moderation system 430, the Application AI 420, or as a standalone system. Content moderation feature 440 may be embodied as system 800 described with respect to FIG. 8. Content moderation system 430 whether incorporating content moderation feature 440 or not can also be embodied as described with respect to system 800. Application AI 420 (or certain portions thereof) may be implemented on user device 410. However, in many cases, Application AI 420 is at least partially implemented as a user service in a multi-user system and is embodied such as described with respect to system 800.

FIG. 5 illustrates a method carried out by a content moderation service. Referring to FIG. 5, method 500 can include receiving (510) a system generated content from an application identified as a result of detecting a trigger associated with a content moderation list in the system generated content. The application may be a content creation application or any other application with an associated application artificial intelligence feature that can provide system generated content that may be surfaced to a user via a user interface (e.g., graphical user interface or audio interface). As described with respect to FIGS. 3B and 3C, the content moderation service/feature can receive the system generated content from the application artificial intelligence and may receive all the system generated content (such that the content moderation service may identify whether the content includes a trigger) or just receive the system generated content that is already identified as being a trigger. The trigger associated with a content moderation list is a word, phrase, image, audio, or video indicated as requiring a moderation action. FIGS. 6A and 6B illustrate additional examples of content that may be identified as a trigger.

Method 500 further includes receiving (520) context for the trigger, where the context for the trigger includes other words or phrases or images (or other media) in proximity to the trigger. The context can be user generated content or system generated content surrounding the trigger content. The context for the trigger can be a sentence or sentence fragment to which the trigger belongs, an image on which the trigger is disposed, or one or more words located on an image, as some examples. Context may include associated user generated content, such as the immediately preceding user generated content (e.g., “This is the last day of my,” of FIG. 3A). Context may also include any of the user generated content in the file the user is working on in the Application. This user generated content may include any words, phrases, and images or other media located within the Application. In some embodiments, context may be actively provided by the user in the form of settings or affirmative actions. Context may also include any system generated content previously added to the file the user is working on in the Application. In some cases, the content moderation service receives the context when receiving the system generated content in operation 510; however, in other cases, the content moderation service receives the context in response to requesting the context.

Method 500 further includes evaluating (530) the trigger in combination with the context for the trigger according to a content moderation process to obtain a determination of a risk assessment. In some cases, the content moderation process is carried out by a content moderation system that conventionally performs content moderation of user generated content.

Method 500 further includes providing (540) the risk assessment to the application for determining the moderation action. The risk assessment and/or a recommendation of the moderation action can be provided to the application via the application AI.

FIGS. 6A and 6B illustrate example scenarios of system generated content being evaluated using a content moderation service. In the scenario illustrated in FIG. 6A, an Inspirational Quote Poster Generator created a poster, which is entirely system generated content. The described content moderation service can be used by the Poster Generator application to ensure that the AI generated content 600 is reviewed for sensitive content. For example, the image 610 of the spoon and the phrase 620 “fire it up!” are not on their own problematic, but a moderation list can include either or both of these content as a trigger requiring further evaluation since, in combination, the context may be considered related to drug use. The system generated content can be evaluated by the content moderation system via the content moderation service and a determination made that a risk assessment related to “warning drug related” can be obtained and provided for determining a moderation action.

FIG. 6B illustrates another example of a combination of text and images, some of which is system generated, that can be evaluated using the described content moderation service. For example, the image 630 of the gun may be a trigger requiring content moderation review, but the combination 640 of the image 630 and the text 650 “Gun Safety Course” can be evaluated together such that a risk assessment indicating a recommendation of moderation action of “none needed” can be provided back to the system.

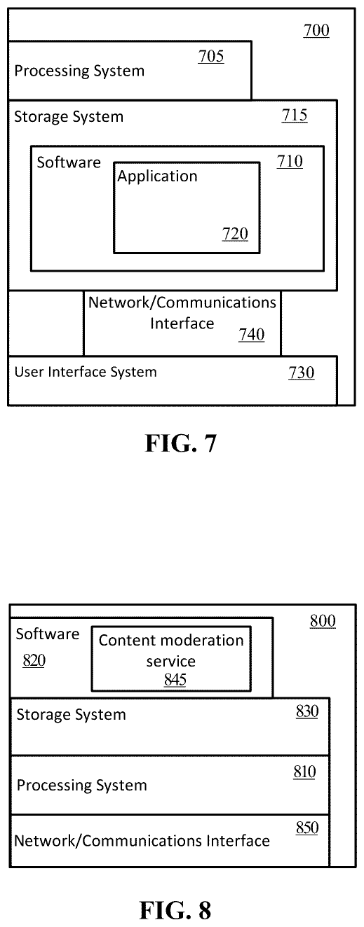

FIG. 7 illustrates components of a computing device on which a user may create user generated content. Device 700 includes a processing system 705 of one or more processors to transform or manipulate data according to the instructions of software 710 stored on a storage system 715. Examples of processors of the processing system 705 include general purpose central processing units, application specific processors, and logic devices, as well as any other type of processing device, combinations, or variations thereof. The processing system 705 may be, or is included in, a system-on-chip (SoC) along with one or more other components such as network connectivity components, sensors, video display components.

The software 710 can include an operating system (not shown) and application programs such as application 720 that includes an AI feature. Application 720 may be a content creation application or other productivity application.

Storage system 715 may comprise any computer readable storage media readable by the processing system 705 and capable of storing data and software 710 including the application 720.

Storage system 715 may include volatile and nonvolatile memories, removable and non-removable media implemented in any method or technology for storage of information, such as computer readable instructions, data structures, program modules, or other data. Examples of storage media of storage system 715 include random access memory, read only memory, magnetic disks, optical disks, CDs, DVDs, flash memory, magnetic cassettes, magnetic tape, magnetic disk storage or other magnetic storage devices, or any other suitable storage media. In no case are the storage media of storage system a transitory propagated signal.

The device 700 can further include user interface system 730, which may include input/output (I/O) devices and components that enable communication between a user and the system 700. User interface system 730 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input. The user interface system 730 may also include output devices such as display screen(s), speakers, haptic devices for tactile feedback, and other types of output devices. In certain cases, the input and output devices may be combined in a single device, such as a touchscreen, or touch-sensitive, display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display (not shown) in myriad ways, presenting graphical user interface elements, text, images, video, notifications, virtual buttons, virtual keyboards, or any other type of information capable of being depicted in visual form.

The user interface system 730 may also include user interface software and associated software (e.g., for graphics chips and input devices) executed by the operating system (OS) in support of the various user input and output devices. The associated software assists the OS in communicating user interface hardware events to application programs using defined mechanisms. The user interface system 730 including user interface software may support a graphical user interface, a natural user interface, or any other type of user interface. For example, the graphical user interfaces for the application 720 described herein (e.g., shown in FIGS. 3A and 3D) may be presented through user interface system 730.

Network/communications interface 740 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the operating system, which informs applications of communications events when necessary.

FIG. 8 illustrates components of a computing system that may be used to carry out processes described herein. Referring to FIG. 8, system 800 may be implemented within a single computing device or distributed across multiple computing devices or sub-systems that cooperate in executing program instructions. The system 800 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 800 can include a processing system 810, which may include one or more processors and/or other circuitry that retrieves and executes software 820 from storage system 830. Processing system 810 may be implemented within a single processing device but may also be distributed across multiple processing devices or sub-systems that cooperate in executing program instructions.

Storage system(s) 830 can include any computer readable storage media readable by processing system 810 and capable of storing software 820. Storage system 830 may be implemented as a single storage device but may also be implemented across multiple storage devices or sub-systems co-located or distributed relative to each other. Storage system 830 may include additional elements, such as a controller, capable of communicating with processing system 810.

Software 820 can include instructions for the content moderation service 845 (and support associated APIs), which may perform processes as described with respect to FIGS. 2, 3A-3D, and 5. Although system 800 is specifically shown and described with instructions for a content moderation feature, the components described with respect to system 800 can be used to implement the content moderation system and the application AI through inclusion of corresponding instructions (and/or hardware) for performing those processes.

System 800 may represent any computing system on which software 820 may be staged and from where software 820 may be distributed, transported, downloaded, or otherwise provided to yet another computing system for deployment and execution, or yet additional distribution.

In embodiments where the system 800 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A network/communications interface 850 may be included, providing communication connections and devices that allow for communication between system 800 and other computing systems (not shown) over a communication network or collection of networks (not shown) or the air. The network can be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

Communication to and from the system 800 and other computing systems (not shown) may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Certain techniques set forth herein with respect to the application and/or content frame platform may be described in the general context of computer-executable instructions, such as program modules, executed by one or more computing devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain embodiments may be implemented as a computer process, a computing system, or as an article of manufacture, such as a computer program product or computer-readable storage medium. Certain methods and processes described herein can be embodied as software, code and/or data, which may be stored on one or more storage media. Certain embodiments of the invention contemplate the use of a machine in the form of a computer system within which a set of instructions, when executed by hardware of the computer system (e.g., a processor or processing system), can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving a system generated content from an application identified as a result of detecting a trigger associated with a content moderation list in the system generated content, wherein the trigger associated with a content moderation list is a word, phrase, image, audio, or video indicated as requiring a moderation action;
receiving context for the trigger, wherein the context for the trigger comprises other words or phrases or images in proximity to the trigger;
evaluating the trigger in combination with the context for the trigger according to a content moderation process to obtain a determination of a risk assessment; and
providing the risk assessment to the application for determining the moderation action to the application.

2. The method of claim 1, wherein the context for the trigger is a sentence or sentence fragment to which the trigger belongs.

3. The method of claim 1, wherein the context for the trigger is an image or video on which the trigger is disposed.

4. The method of claim 1, wherein the context for the trigger comprises one or more words located on an image or video.

5. The method of claim 1, wherein the context for the trigger comprises user generated content, wherein the user generated content comprises a same content used by the application to generate the system generated content.

6. The method of claim 1, the method further comprising:
requesting a tracking set of system generated content and associated content used by the application to generate each system generated content of the tracking set of system generated content; and
evaluating the tracking set of system generated content and associated content according to the content moderation process to identify any system generated content of the tracking set of system generated content that results in a particular moderation action or particular risk assessment.

7. The method of claim 6, wherein the associated content used by the application to generate each system generated content of the tracking set of system generated content comprises user generated content.

8. The method of claim 6, wherein the application comprises an artificial intelligence feature for generating the system generated content, the method further comprising:
labeling each identified system generated content of the tracking set of system generated content that results in the particular moderation action or the particular risk assessment as a new trigger; and
communicating with the application or the artificial intelligence feature to update a model with the new triggers.

9. The method of claim 6, further comprising:
performing statistical analysis with respect to each identified system generated content of the tracking set of system generated content that results in the particular moderation action or the particular risk assessment.

10. A computing system comprising:
a processor;
a storage medium; and
instructions for a content moderation feature stored on the storage medium that when executed by the processor direct the computing system to:
receive a system generated content from an application identified as a result of detecting a trigger associated with a content moderation list in the system generated content, wherein the trigger associated with a content moderation list is a word, phrase, image, audio, or video indicated as requiring a moderation action;
receive context for the trigger, wherein the context for the trigger comprises other words or phrases or images in proximity to the trigger;
evaluate the trigger in combination with the context for the trigger according to a content moderation process to obtain a determination of the moderation action; and
provide a risk assessment to the application for determining the moderation action.

11. The computing system of claim 10, wherein the context for the trigger comprises user generated content, wherein the user generated content comprises a same content used by the application to generate the system generated content.

12. The computing system of claim 10, further comprising instructions that direct the computing system to:
request a tracking set of system generated content and associated content used by the application to generate each system generated content of the tracking set of system generated content; and
evaluate the tracking set of system generated content and associated content according to the content moderation process to identify any system generated content of the tracking set of system generated content that results in a particular moderation action or particular risk assessment.

13. The computing system of claim 12, wherein the associated content used by the application to generate each system generated content of the tracking set of system generated content comprises user generated content.

14. The computing system of claim 12, wherein the application comprises an artificial intelligence feature for generating the system generated content, the instructions further directing the computing system to:
label each identified system generated content of the tracking set of system generated content that results in the particular moderation action or the particular risk assessment as a new trigger; and
communicate with the application or the artificial intelligence feature to update a model with the new triggers.

15. The computing system of claim 12, further comprising instructions that direct the computing system to:
perform statistical analysis with respect to each identified system generated content of the tracking set of system generated content that results in the particular moderation action or the particular risk assessment.

16. A computer readable storage medium having instructions stored thereon that when executed by a computing system, direct the computing system to:
receive a system generated content from an application identified as a result of detecting a trigger associated with a content moderation list in the system generated content, wherein the trigger associated with a content moderation list is a word, phrase, image, audio, or video indicated as requiring a moderation action;
receive context for the trigger, wherein the context for the trigger comprises other words or phrases or images in proximity to the trigger;
evaluate the trigger in combination with the context for the trigger according to a content moderation process to obtain a determination of a risk assessment; and
provide the risk assessment to the application for determining the moderation action.

17. The computer readable storage medium of claim 16, further comprising instructions that direct the computing system to:
request a tracking set of system generated content and associated content used by the application to generate each system generated content of the tracking set of system generated content; and
evaluate the tracking set of system generated content and associated content according to the content moderation process to identify any system generated content of the tracking set of system generated content that results in a particular moderation action or particular risk assessment.

18. The computer readable storage medium of claim 17, wherein the associated content used by the application to generate each system generated content of the tracking set of system generated content comprises user generated content.

19. The computer readable storage medium of claim 17, wherein the application comprises an artificial intelligence feature for generating the system generated content, the instructions further directing the computing system to:
label each identified system generated content of the tracking set of system generated content that results in the particular moderation action or the particular risk assessment as a new trigger; and
communicate with the application or the artificial intelligence feature to update a model with the new triggers.

20. The computer readable storage medium of claim 17, further comprising instructions that direct the computing system to:
perform statistical analysis with respect to each identified system generated content of the tracking set of system generated content that results in the particular moderation action or the particular risk assessment.
